(19) United States
(12) Patent Application Publication
(10) Pub. No.: US 2025/0309430 A1
(43) Pub. Date: Oct. 2, 2025

(54) BATTERY MODULE AND BATTERY PACK INCLUDING THE SAME

(71) Applicant: SK On Co., Ltd., Seoul (KR)

(72) Inventors: Dong Jin KIM, Daejeon (KR); Keun Woo CHOI, Daejeon (KR); Sung Yeon KIM, Daejeon (KR); Jin A JANG, Daejeon (KR)

(21) Appl. No.: 19/090,399

(22) Filed: Mar. 26, 2025

(30) Foreign Application Priority Data
Apr. 2, 2024 (KR) 10-2024-0044577

(51) Int. Cl. H01M 50/211; H01M 50/105; H01M 50/133; H01M 50/291; H01M 50/505; H01M 50/533

(52) U.S. Cl. CPC H01M 50/211; H01M 50/105; H01M 50/133; H01M 50/291; H01M 50/505; H01M 50/533

(57) ABSTRACT

A battery module including a cell assembly including a plurality of battery cells, each of the plurality of battery cells including a body portion accommodating an electrode assembly, a sealing portion sealing at least a portion of a periphery of the body portion, and an electrode lead electrically connected to the electrode assembly; and a thickness compensation portion disposed between at least some battery cells among the plurality of battery cells, wherein the body portion includes a uniform thickness region including a central portion of the body portion, and a low thickness region disposed adjacent to the electrode lead than uniform thickness region, and the thickness compensation portion has a shape covering at least a portion of the low thickness region and not covering at least a portion of the uniform thickness region, is disclosed.

### CROSS-REFERENCE TO RELATED APPLICATION(S)

This patent document claims the priority and benefits of Korean Patent Application No. 10-2024-0044577 filed on Apr. 2, 2024, the disclosure of which is incorporated herein by reference in its entirety.

### TECHNICAL FIELD

The disclosure and implementations disclosed in this patent document generally relate to a battery module including a plurality of secondary battery cells capable of charging and discharging electricity, and a battery pack including the same.

### BACKGROUND

As development of technology and demand for a mobile device, an electric vehicle, an energy storage device, etc. increase, demand for a secondary battery cell as an energy source is rapidly increasing. A secondary battery cell may be a battery in which mutual conversion between chemical energy and electrical energy is reversible to repeat charging and discharging.

A battery cell may include an electrode assembly including a positive electrode plate, a negative electrode plate, a separator, etc., and an electrolyte. The battery cell may be configured as a pouch-type battery cell or a square or cylindrical can-type battery cell.

A plurality of battery cells may be disposed in a certain pattern to configure a battery module or a battery pack, and may be used for various purposes such as an electric vehicle, an energy storage system (ESS), or the like.

### SUMMARY

As a secondary battery cell is charged and discharged, a volume of the battery cell expands, causing a swelling phenomenon. The swelling phenomenon may occur due to solid expansion caused by charging and discharging, gas generation in a high-temperature environment, or the like. When the swelling phenomenon occurs, the battery cell may swell, and a lifespan of the battery cell and battery module may thus be reduced due to surface pressure imbalance between battery cells in the battery module.

In order to deal with this swelling phenomenon, a compressible member such as a pad may be disposed around the battery cell to alleviate the surface pressure imbalance between the battery cells.

However, when there is a thickness deviation in an electrode assembly depending on a position of an electrode plate constituting the electrode assembly, there may be a limit to resolving the surface pressure imbalance through the compressible pad. When the surface pressure imbalance occurs in the battery cells, a sudden drop in capacity of the battery cells or a rapid increase in resistance may occur in a portion in which a surface pressure is low.

According to an aspect of the present disclosure, a battery module having an increased lifespan by reducing surface pressure imbalance applied to a battery cell and a battery pack including the same may be provided.

According to an aspect of the present disclosure, a battery module capable of limiting a rapid decrease in capacity or a rapid increase in resistance of a battery cell due to surface pressure imbalance, and a battery pack including the same, may be provided.

According to an aspect of the present disclosure, a battery module capable of limiting a decrease in capacity and/or an increase in resistance of a battery cell while reducing effect on an energy density, and a battery pack including the same may be provided.

A battery module of the present disclosure and a battery pack including the same may be widely applied in green technology fields such as an electric vehicle, a battery charging station, or solar power generation, wind power generation, or the like, using batteries, or the like. In addition, a battery module of the present disclosure and a battery pack including the same may be used in an eco-friendly electric vehicle, a hybrid vehicle, or the like, to prevent a change in climate by suppressing air pollution and greenhouse gas emissions.

A battery module according to the present disclosure includes a cell assembly including a plurality of battery cells, each of the plurality of battery cells including a body portion accommodating an electrode assembly, a sealing portion sealing at least a portion of a periphery of the body portion, and an electrode lead electrically connected to the electrode assembly; and a thickness compensation portion disposed between at least some battery cells among the plurality of battery cells, wherein the body portion includes a uniform thickness region including a central portion of the body portion, and a low thickness region disposed adjacent to the electrode lead than the uniform thickness region, and the thickness compensation portion has a shape covering at least a portion of the low thickness region and not covering at least a portion of the uniform thickness region.

In an embodiment, if a difference between an average thickness of the electrode assembly in the uniform thickness region and a thickness of the electrode assembly in the low thickness region is referred to as a thickness deviation, a thickness of the thickness compensation portion may have a value less than or equal to a maximum value of the thickness deviation.

In an embodiment, the thickness of the thickness compensation portion may be a value measured in a state in which the thickness compensation portion is not compressed, when the thickness compensation portion is an incompressible material, and a value measured in a state in which the thickness compensation portion is compressed by a preset value, when the thickness compensation portion is a compressible material.

In an embodiment, the thickness compensation portion may include an electrically insulating material.

In an embodiment, the thickness compensation portion may have a constant thickness in a first direction in which the electrode lead extends from the electrode assembly.

In an embodiment, in a first direction in which the electrode lead extends from the electrode assembly, a thickness of a portion of the thickness compensation portion adjacent to the electrode lead may be greater than a thickness of a portion of the thickness compensation portion distant from the electrode lead.

In an embodiment, the thickness compensation portion may have a stepped cross-sectional shape.

In an embodiment, the thickness compensation portion may have a shape of which a thickness decreases from a portion adjacent to the electrode lead to a portion distant from the electrode lead.

In an embodiment, the thickness compensation portion may have a height, equal to or greater than a height of an electrode plate provided in the electrode assembly.

In an embodiment, an inner side portion of the thickness compensation portion may have a shape in which an outer side portion of the thickness compensation portion in a height direction extends further toward the uniform thickness region than a central portion in the height direction.

In an embodiment, a width of the thickness compensation portion in a first direction in which the electrode lead extends from the electrode assembly may have a value of 0.5 to 2.0 times a width of the low thickness region.

In an embodiment, the electrode lead may have a shape extending from both sides of the electrode assembly, the low thickness region may be located on both sides of the body portion, and the thickness compensation portion may be disposed on the low thickness region, respectively.

In an embodiment, the electrode lead may have a shape extending from one side of the electrode assembly, the low thickness region may be located in one side of the body portion, and the thickness compensation portion may be disposed on the low thickness region located in the one side of the body portion.

In an embodiment, a battery module may further include a busbar assembly including a busbar connected to an electrode lead of a battery cell, and a support plate supporting the busbar, wherein the thickness compensation portion may be connected to the support plate.

In an embodiment, the thickness compensation portion may be formed integrally with the support plate or attached to the support plate.

A battery pack according to the present disclosure includes a plurality of battery modules; and a pack housing accommodating the plurality of battery modules, wherein at least one battery module, among the plurality of battery modules, includes a cell assembly including a plurality of battery cells, each of the plurality of battery cells including a body portion accommodating an electrode assembly, a sealing portion sealing at least a portion of a periphery of the body portion, and an electrode lead electrically connected to the electrode assembly; and a thickness compensation portion disposed between at least some battery cells among the plurality of battery cells, wherein the body portion includes a uniform thickness region including a central portion of the body portion, and a low thickness region disposed adjacent to the electrode lead than the uniform thickness region, and the thickness compensation portion has a shape covering at least a portion of the low thickness region and not covering at least a portion of the uniform thickness region.

### BRIEF DESCRIPTION OF DRAWINGS

Certain aspects, features, and advantages of the present disclosure may be illustrated by the following detailed description with reference to the accompanying drawings.

FIG. 1 is a perspective view illustrating a battery module according to an embodiment.

FIG. 2 is an exploded perspective view of the battery module illustrated in FIG. 1.

FIG. 3 is a perspective view of a battery cell according to an embodiment.

FIG. 4 is a cross-sectional view of the battery cell of FIG. 3, taken along line I-I′.

FIGS. 5A and 5B are cross-sectional views illustrating the plurality of battery cells and the thickness compensation portion of FIG. 2, taken along line II-II′, in which FIG. 5A illustrates a state before the battery cells are pressurized, and FIG. 5B illustrates a state in which the battery cells are pressurized.

FIG. 6 is a schematic view illustrating a state in which a thickness compensation portion is installed on both side surfaces of a battery cell, in which an upper portion in the drawing illustrates a side surface of the battery cell, and a lower portion in the drawing illustrates a plane of the battery cell.

FIG. 7 is a cross-sectional view illustrating a modified example having arrangement of the thickness compensation portion illustrated in FIG. 5B.

FIG. 8 is a graph illustrating a thickness deviation ΔT of an electrode assembly in a battery cell according to an embodiment.

FIG. 9 is a schematic view illustrating a change in thickness of an electrode assembly in a portion adjacent to an electrode lead.

FIG. 10 illustrates electrode plates, in which portion (a) of FIG. 10 is a plan view of the electrode plate, and portion (b) of FIG. 10 is a cross-sectional view of the electrode plate.

FIGS. 11A and 11B are schematic views illustrating a battery cell in which an electrode lead is disposed on one side of a pouch.

FIG. 12 illustrates electrode plates, in which portion (a) of FIG. 12 is a plan view of the electrode plate, and portion (b) of FIG. 12 is a cross-sectional view of the electrode plate.

FIGS. 13A and 13B are cross-sectional views illustrating a shape of an edge area.

FIG. 14A is a schematic view illustrating a state in which a thickness compensation portion according to a modified example is installed on both side surfaces of a battery cell, in which an upper portion in the drawing illustrates a side surface of the battery cell, and a lower portion in the drawing illustrates a plane of the battery cell.

FIG. 14B is a cross-sectional view illustrating a state in which the thickness compensation portion illustrated in FIG. 14A is disposed between battery cells.

FIG. 14C is a perspective view of the thickness compensation portion illustrated in FIG. 14A.

FIG. 15 is a cross-sectional view illustrating a state in which a thickness compensation portion according to another modified example is disposed between battery cells.

FIG. 16 is a schematic view illustrating a state in which a thickness compensation portion according to another modified example is installed on both side surfaces of a battery cell, in which an upper portion in the drawing illustrates a side surface of the battery cell, and a lower portion in the drawing illustrates a plane of the battery cell.

FIG. 17 is a cross-sectional view of FIG. 2, taken along line III-III′.

FIG. 18 is a cross-sectional view illustrating a modified example of FIG. 17.

FIG. 19 is a cross-sectional view illustrating a state in which a modified example of the thickness compensation portion illustrated in FIG. 17 is applied.

FIG. 20 is a perspective view illustrating a battery pack according to an embodiment.

### DETAILED DESCRIPTION

The same reference numbers or symbols in each drawing attached to this specification indicate parts or components that perform substantially the same function. For convenience of explanation and understanding, different embodiments may be described using the same reference numerals or symbols. That is, even when components having the same reference number may be illustrated in multiple drawings, the multiple drawings do not all represent an embodiment.

In the following description, singular expressions include plural expressions unless the context clearly dictates otherwise. Terms such as “include,” “comprise,” or the like, may be intended to designate the presence of features, numbers, steps, operations, components, parts, or combinations thereof described in the specification, and one or more other features or numbers, it should be understood that this does not exclude in advance possibility of presence or addition of steps, operations, components, parts, or combinations thereof.

In addition, in the following description, expressions such as upward, above, on, upper portion, downward, below, lower portion, lateral, side surface, forward, front, rearward, rear, or the like may be expressed based on the direction illustrated in the drawings, and it should be noted in advance that when a direction of an object changes, it may be expressed differently.

Additionally, in the present specification and claims, terms including ordinal numbers such as “first,” “second,” or the like may be used to distinguish between components. These ordinal numbers may be used to distinguish identical or similar components from each other, and the meaning of the term should not be interpreted limitedly due to the use of these ordinal numbers. For example, components combined with these ordinal numbers should not be interpreted as having a limited order of use or arrangement based on the number. As necessary, each ordinal number may be used interchangeably.

Hereinafter, embodiments of the present disclosure will be described with reference to the attached drawings. However, the idea of the present disclosure is not limited to the presented embodiments.

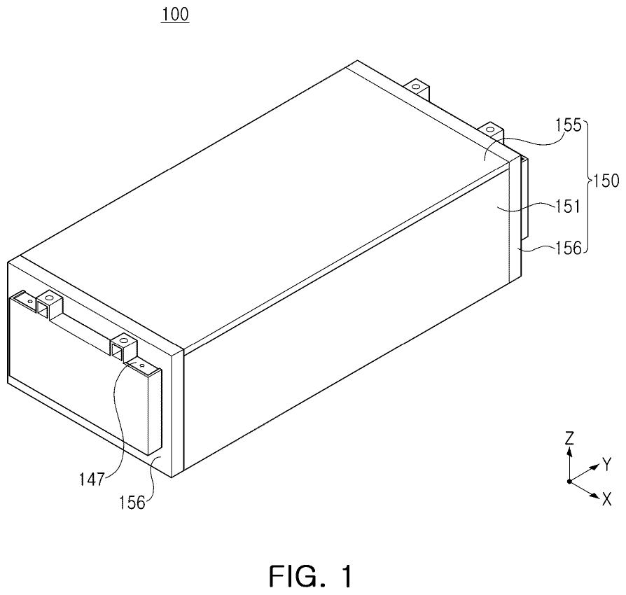

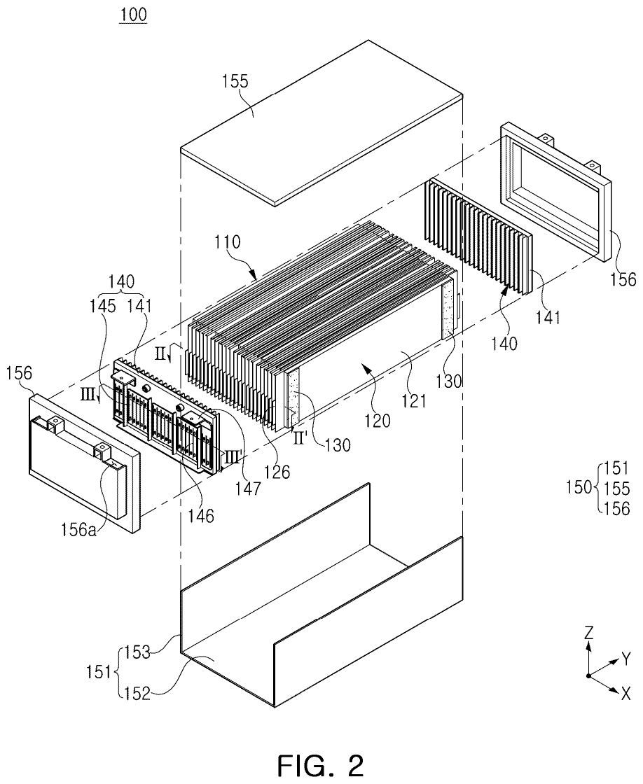

FIG. 1 is a perspective view illustrating a battery module 100 according to an embodiment, and FIG. 2 is an exploded perspective view of the battery module 100 illustrated in FIG. 1.

Referring to FIGS. 1 and 2, a battery module 100 according to an embodiment may include a cell assembly 110 including a plurality of battery cells 120 and a thickness compensation portion 130 disposed between at least some battery cells 120 among the plurality of battery cells 120. A battery module 100 according to an embodiment may include a busbar assembly 140 having a busbar 145 connected to an electrode lead 126 of the battery cell 120 and a support plate 141 supporting the busbar 145. A battery module 100 according to an embodiment may additionally include a module housing 150 accommodating the cell assembly 110.

The cell assembly 110 may have a shape in which the plurality of battery cells 120 are stacked. In an embodiment, the plurality of battery cells 120 may be stacked in a state in which wide surfaces face each other. For example, the plurality of battery cells 120 may be stacked in a second direction (X). However, it is also possible to have a shape in which the plurality of battery cells 120 are stacked in a gravity direction (e.g., third direction) (Z), as needed.

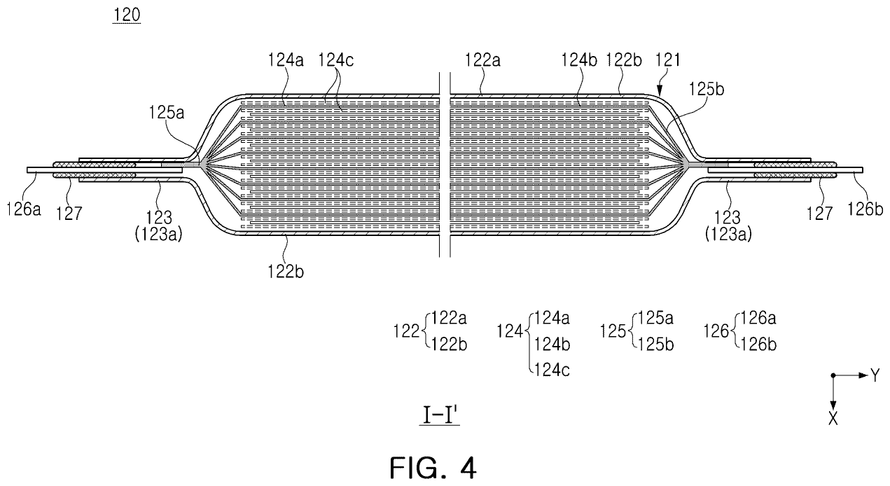

Each of the battery cells 120 may be configured as a pouch-type battery cell in which an electrode assembly (124 of FIG. 4) is accommodated in a pouch (outer material) 121. Each of the battery cells 120 may include an electrode lead 126 exposed to an outside of the pouch 121. The electrode lead 126 may be electrically connected to an electrode assembly 124.

In the battery cell 120 of the present disclosure, a width direction (length direction) means a first direction (Y) in which the electrode lead 126 extends from the electrode assembly (124 of FIG. 4), a thickness direction means the second direction (X), perpendicular to a wide surface of the pouch 121, and a height direction (up-down direction or gravity direction) means the third direction (Z), perpendicular to the width direction and the thickness direction.

The busbar assembly 140 may include the electrically conductive busbar 145 electrically connected to the electrode lead 126 of the battery cell 120, and the support plate 141 having an electrically insulating property. The support plate 141 may be disposed between the plurality of battery cells 120 and the electrically conductive busbar 145, to support the busbar 145. The support plate 141 may electrically insulate between the busbar 145 and the pouch 121 of the battery cell 120. For example, the busbar 145 may be fixed to the support plate 141 in a hooked or fusion state. A method of coupling the busbar 145 to the support plate 141 may be changed in various manners.

The busbar assembly 140 may be disposed in a position facing the electrode leads 126 of the battery cell 120, and may be electrically connected to the plurality of electrode leads 126. For example, when the electrode leads 126 are disposed on both ends of the battery cell 120 in the first direction (Y), the busbar assembly 140 may be disposed on both ends of the battery cell 120 in the first direction (Y), and may be coupled to the electrode leads 126.

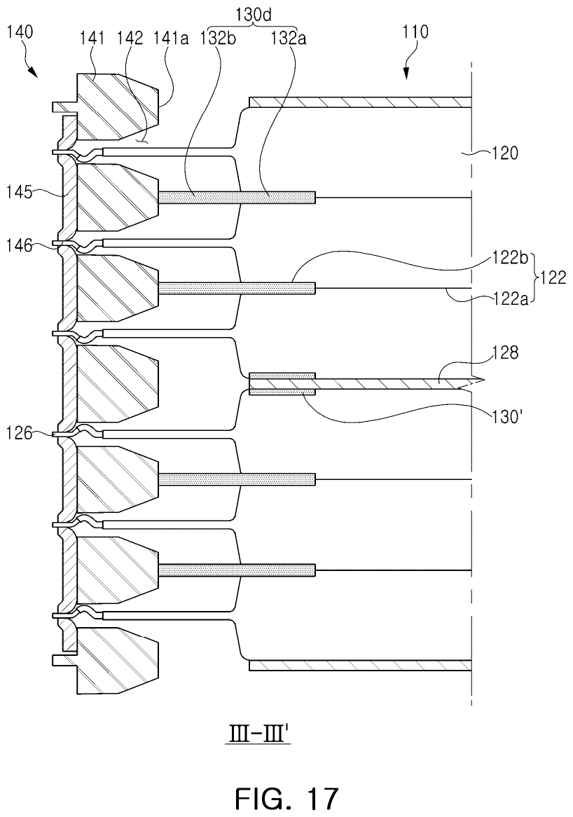

The electrode lead 126 may penetrate the support plate 141 of the busbar assembly 140, to be coupled to the busbar 145 on an outside of the busbar assembly 140. To this end, the support plate 141 may include a through-portion (142 of FIG. 17) through which the electrode lead 126 passes, and the busbar 145 may include a coupling hole 146 through which the electrode lead 126 passes and is coupled. The electrode lead 126 may be welded to the busbar 145 while penetrating the coupling hole 146. The plurality of battery cells 120 may be electrically connected in series and/or in parallel by the plurality of busbars 145.

The busbar assembly 140 may include a connection terminal 147 for electrical connection between the busbar 145 and an external source. The battery cell 120 may be electrically connected to the external source through the connection terminal 147. The connection terminal 147 may be exposed to the external source through a through-hole 156a formed in an end plate 156, as illustrated in FIG. 2.

The module housing 150 may have a structure covering at least a portion of the cell assembly 110. The module housing 150 may form at least a portion of an exterior of the battery module 100.

The module housing 150 may have various shapes or divided structures. As an example, the module housing 150 may be configured to include a housing body 151 having a cross-sectional shape of which one side is exposed, and a housing cover 155 that may be combined with the housing body 151 to form an internal space. The housing cover 155 may cover a top surface of the cell assembly 110. The housing body 151 may include a lower plate 152 supporting a lower portion of the cell assembly 110, and a side plate 153 extending from both ends of the lower plate 152 in the third direction (Z) and supporting a side surface of the cell assembly 110. In addition, the module housing 150 may have a structure in which end plates 156 are coupled to front and rear surfaces of the module housing 150 in a length direction. The end plates 156 may be coupled to both side surfaces in which the electrode leads 126 of the battery cells 120 are disposed, for example, in both sides of the module housing 150 in the first direction (Y).

The cell assembly 110 may be disposed on an inside of the module housing 150. At least one surface forming the module housing 150 may function as a heat dissipation plate dissipating heat generated from the battery cells 120 externally. At least a portion of the module housing 150 may be comprised of a material having high thermal conductivity, such as metal. For example, the module housing 150 may include aluminum. A material of the housing body 151 may not be limited thereto, and various materials may be used as long as they have strength and thermal conductivity similar to metal, even when they are not metal.

Although the module housing 150 in FIGS. 1 and 2 are illustrated as having a structure completely surrounding an outer surface of the cell assembly 110, the module housing 150 may also be configured such that at least one surface of the cell assembly 110 is exposed externally. For example, the module housing 150 may also have a configuration that does not cover a lower surface of the cell assembly 110.

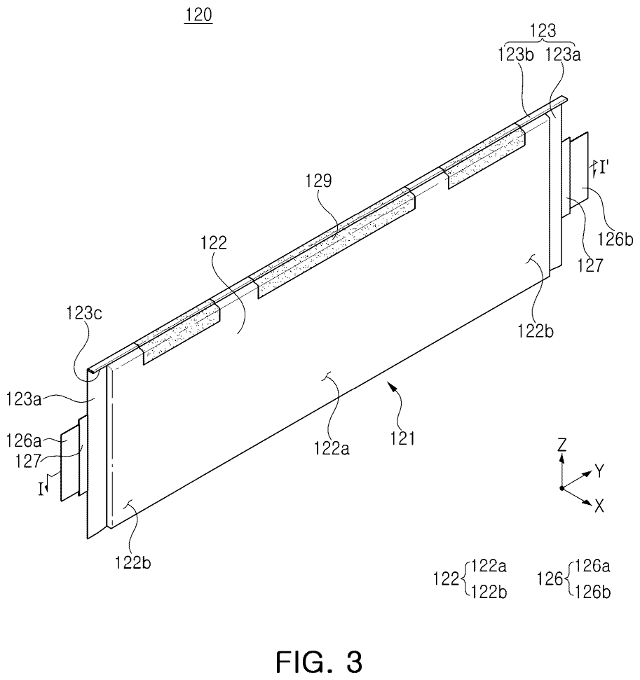

FIG. 3 is a perspective view of a battery cell 120 according to an embodiment, and FIG. 4 is a cross-sectional view of the battery cell of FIG. 3, taken along line I-I′.

Referring to FIGS. 3 and 4, a battery cell 120 may include a pouch-type battery cell in which an electrode assembly 124 is accommodated in a flexible pouch 121.

The battery cell 120 may include a body portion 122 accommodating the electrode assembly 124 therein, a sealing portion 123 extending from at least a portion of a periphery of the body portion 122 to seal the body portion 122, and an electrode lead 126 electrically connected to the electrode assembly 124.

The pouch 121 may be formed in a container shape to provide an internal space in which the electrode assembly 124 and an electrolyte are accommodated. For example, the pouch 121 may be comprised of an outer sheet laminated with a resin such as polypropylene or the like, aluminum, and the like. A material forming the pouch 121 may be variously changed.

The pouch 121 may include the body portion 122 and the sealing portion 123. The body portion 122 may be formed in a container shape, and may provide an internal space of a certain shape (e.g., hexahedron) in which the electrode assembly 124 and the electrolyte are accommodated. The body portion 122 may include a uniform thickness region 122a including a central portion of the body portion 122, and a low thickness region 122b disposed adjacent to the electrode lead 126 than the uniform thickness region 122a.

The sealing portion 123 may extend from at least a portion of the periphery of the body portion 122. The sealing portion 123 may be formed in a flange shape extending from at least a portion of the periphery of the body portion 122 in an outward direction. For example, when a single outer sheet is folded to form the pouch 121, the sealing portion 123 may have a shape extending from three surfaces of four surfaces of the body portion 122. In contrast, when two outer sheets are folded to form the pouch 121, the sealing portion 123 may have a shape extending from all four surfaces of the body portion 122. The sealing portion 123 may have a state in which outer sheets forming the pouch 121 are folded or covered with each other. The sealing portion 123 may include a portion in which the outer sheets folded with each other are joined to seal the body portion 122. A heat-melting method may be used for joining the sealing portion 123, but is not limited thereto.

The electrode assembly 124 may include a plurality of electrode plates and a plurality of separators 124c, and may be accommodated in the internal space of the body portion 122. The electrode plates may include a positive electrode plate 124a and a negative electrode plate 124b. The electrode assembly 124 may be configured in a form in which the positive electrode plates 124a and the negative electrode plates 124b are stacked with the separator 124c interposed therebetween, in a state in which wide surfaces of the positive electrode plates 124a and the negative electrode plates 124b face each other. The plurality of positive electrode plates and the plurality of negative electrode plates may include an electrode tab 125, respectively. The electrode tab 125 may include a positive electrode tab 125a disposed on the positive electrode plate 124a, and a negative electrode tab 125b disposed on the negative electrode plate 124b. The electrode tab 125 may be connected to the electrode lead 126 such that the same polarities are in contact with each other.

The electrode lead 126 may be exposed externally through a portion of the sealing portion 123. For example, the electrode lead 126 may have a shape extending from the electrode assembly 124 in the first direction (Y), and may be exposed to an outside of the sealing portion 123. The electrode lead 126 may include a positive electrode lead 126a connected to the positive electrode tab 125a of the a positive electrode plate 124a, and a negative electrode lead 126b connected to the negative electrode tab 125b of the negative electrode plate 124b.

In an embodiment, the sealing portion 123 may be divided into a first sealing portion 123a located on a flange in which the electrode lead 126 may be disposed, and a second sealing portion 123b located on a flange in which the electrode lead 126 may not be disposed. In the first sealing portion 123a, the electrode lead 126 may be covered by an insulating portion 127. The insulating portion 127 may increase electrical insulation performance between the electrode lead 126 and the pouch 121, and may increase a sealing degree of a sealed area. The insulating portion 127 may include an insulating film.

In the battery cell 120 illustrated in FIG. 3, the electrode leads 126 are illustrated as being disposed in both sides of the body portion 122 based on the first direction (Y) of the battery cell 120. For example, FIG. 3 illustrates a configuration in which the positive electrode lead 126a and the negative electrode lead 126b are disposed to face opposite directions. However, the positive electrode lead 126a and the negative electrode lead 126b may also be disposed in a spaced state while facing the same direction in one side of the body portion 122.

In an embodiment, to increase joining reliability of the sealing portion 123 and reduce a region occupied by the sealing portion 123, the battery cell 120 may be formed in a form in which some of the sealing portions 123 are folded at least once. For example, the second sealing portion 123b in which the electrode lead 126 is not disposed may include a folding portion 123c folded in the length direction (Y) of the battery cell 120. The folding portion 123c may have a folded shape by at least one folding process. In an embodiment, the battery cell 120 may include at least one tape 129 covering the folding portion 123c, to prevent the folding portion 123c from unfolding, due to an increase in internal pressure of the battery cell 120. The tape 129 may have a shape wrapping around the folding portion 123c.

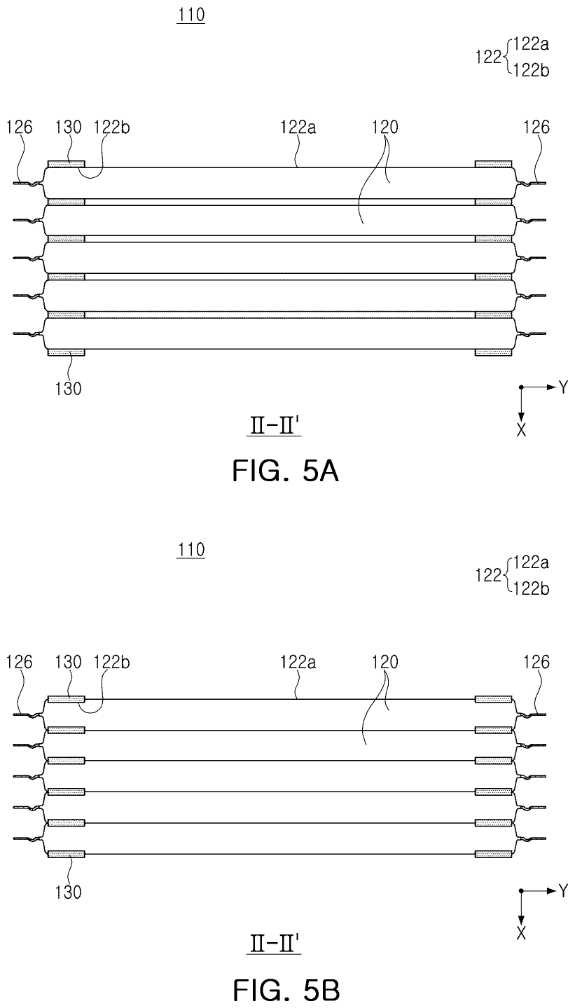

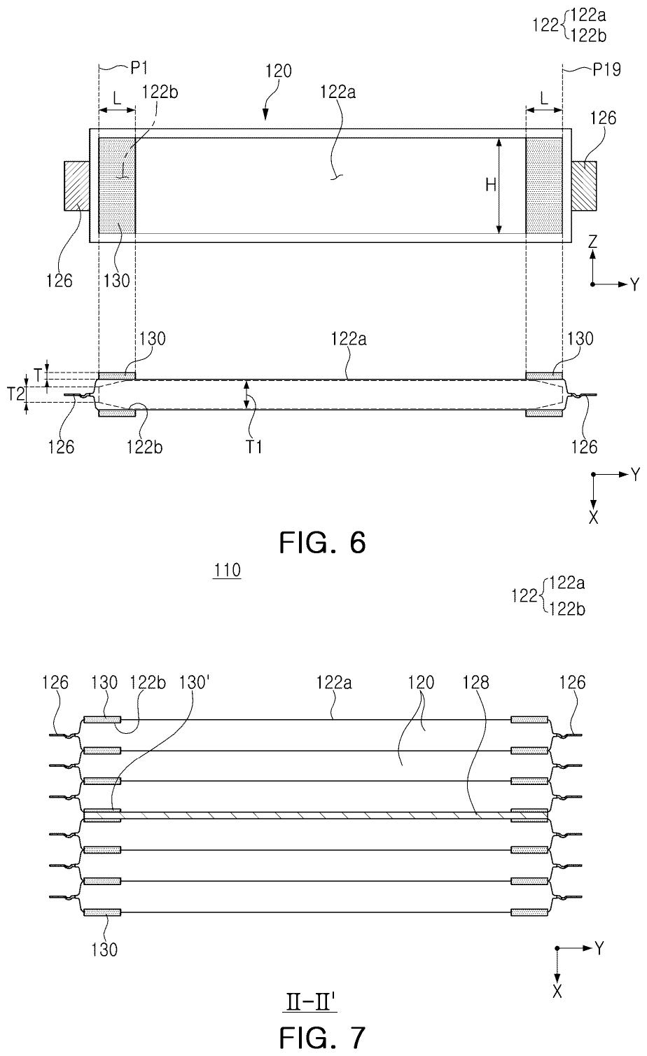

FIGS. 5A and 5B are cross-sectional views illustrating the plurality of battery cells 120 and the thickness compensation portion 130 of FIG. 2, taken along line II-II′, in which FIG. 5A illustrates a state before the battery cells 120 are pressurized, and FIG. 5B illustrates a state in which the battery cells 120 are pressurized. FIG. 6 is a schematic view illustrating a state in which a thickness compensation portion 130 is installed on both side surfaces of a battery cell 120, in which an upper portion in the drawing illustrates a side surface of the battery cell 120, and a lower portion in the drawing illustrates a plane of the battery cell 120. For convenience and clarity, FIGS. 5A, 5B and 6 illustrate an exterior of a battery cell 120 and a cross-section of a thickness compensation portion 130.

Referring to FIGS. 5A to 6 together with FIGS. 3 and 4, a battery module according to an embodiment may include a thickness compensation portion 130 disposed between at least some battery cells 120 among a plurality of battery cells 120.

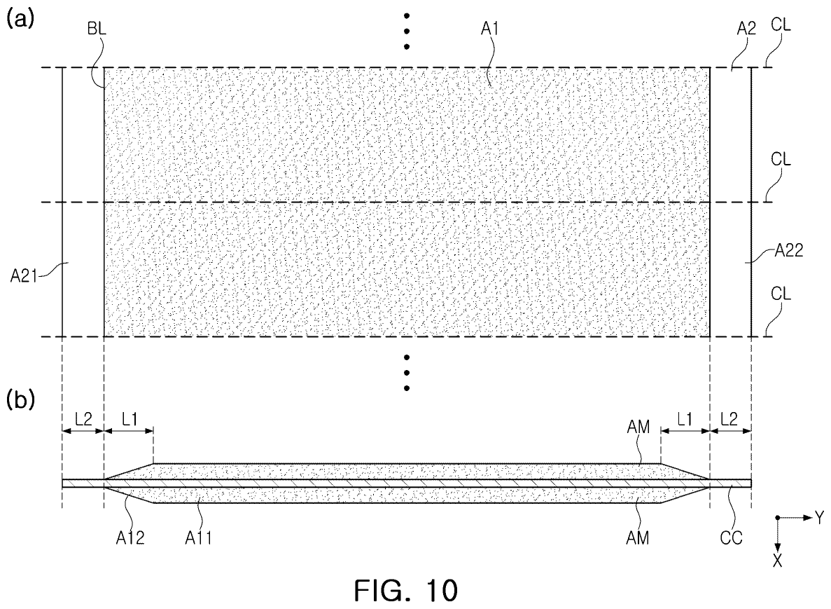

A cell assembly 110 may include a plurality of battery cells 120. A body portion 122 of a battery cell 120 may include a uniform thickness region 122a including a central portion of the body portion 122, and a low thickness region 122b disposed adjacent to an electrode lead 126 than the uniform thickness region 122a. In a region in which a slurry (including an active material, a conductive material, and a binder) (AM of FIG. 10) is applied, an electrode assembly 124 may include a region having a uniform thickness, and a region having a relatively smaller thickness than the region having the uniform thickness. The uniform thickness region 122a and the low thickness region 122b of the body portion 122 may be determined according to a thickness of the electrode assembly 124 located in an inner side of the body portion 122. The uniform thickness region 122a and the low thickness region 122b may be set based on a region in which a slurry (including an active material) is applied or a region in which electrode plates [positive electrode plate 124a and negative electrode plate 124b] are stacked, and an electrode tab 125 may not be included in the low thickness region 122b. The uniform thickness region 122a and the low thickness region 122b may entirely have a rectangular shape.

The uniform thickness region 122a may be defined as a portion of the body portion 122 facing a region of the electrode assembly 124 in which a thickness of the electrode assembly 124 is uniform. In this case, the term ‘uniform thickness’ is not limited to a thickness being completely the same, but means that a thickness of the electrode assembly 124 is included within a certain range (for example, within 3%).

The low thickness region 122b means a portion of the body portion 122 facing a region in which a thickness of the electrode assembly 124 disposed on an inside of the body portion 122 is entirely smaller than the uniform thickness region 122a. For example, the low thickness region 122b may include a region in which the thickness of the electrode assembly 124 is out of a certain range (for example, within 3%) and has a thickness, smaller than the uniform thickness region 122a. In this case, the range may not be fixed to a specific numerical value, and may be changed depending on a thickness deviation of a current collector (metal foil) constituting the electrode plate, a thickness deviation of the slurry including the active material and the like. The low thickness region 122b may be a portion of the body portion 122 facing a region in which a thickness of the electrode assembly 124 is small, in a state in which pressure is applied to the electrode assembly 124.

The low thickness region 122b may be defined as a portion of the body portion 122 facing a region in which a slurry (or active material) is applied to the electrode plate. The low thickness region 122b may extend from an end of the electrode plate in a direction toward an inside of the electrode plate. Referring to FIG. 6, the low thickness region 122b may extend inwardly from a position facing an end position P1 of a first electrode plate (e.g., positive electrode plate) in one side of the body portion 122, in a direction toward an inside of the electrode plate, and may extend from a position facing an end position P19 of a second electrode plate (e.g., negative electrode plate) in the other side of the body portion 122, in a direction toward an inside of the electrode plate.

In this manner, when the electrode leads 126 have a shape extending from both sides of the electrode assembly 124, the low thickness regions 122b may be located on both sides of the body portion 122, and a thickness compensation portion 130 may be disposed on each of the low thickness regions 122b. Thickness compensation portions 130 disposed on both sides of the body portion 122 may be disposed spaced apart from each other with the uniform thickness region 122a therebetween.

The thickness compensation portion 130 may have a shape covering at least a portion of the low thickness region 122b and not covering at least a portion of the uniform thickness region 122a. For example, the thickness compensation portion 130 may have a shape not covering entirety of the uniform thickness region 122a in the first direction (Y) in which the electrode lead 126 extends. For example, the thickness compensation portion 130 may be disposed in a position out of the uniform thickness region 122a, and may be configured to cover the low thickness region 122b. For example, a width L of the thickness compensation portion 130 may have a value corresponding to a length of the low thickness region 122b, and a height H of the thickness compensation portion 130 may have a value greater than or equal to a height of an electrode plate provided in the electrode assembly 124. For example, a height H of the thickness compensation portion 130 may have a value greater than or equal to a height of a positive electrode plate 124a. The thickness compensation portion 130 may entirely cover the electrode assembly 124 in the height direction (Z) of the battery cell 120 in the low thickness region 122b. As an example, the height H of the thickness compensation portion 130 may have a value corresponding to a height of the low thickness region 122b or a height of the body portion 122. The height H of the thickness compensation portion 130 may have a value smaller than the height of the body portion 122. It is also possible to set the height of the thickness compensation portion 130 to have a value greater than or equal to half of a height of an electrode plate provided in the electrode assembly 124.

In a case in which the thickness compensation portion 130 is entirely installed in the first direction (Y) in which the electrode lead 126 extends from the body portion 122, there may be a problem that space efficiency of the battery module is reduced because the thickness compensation portion 130 is installed in a portion in which thickness compensation s not required. In addition, in a case in which the thickness compensation portion 130 is installed not only in the low thickness region 122b in which thickness compensation is required but also in the uniform thickness region 122a in which thickness compensation is not required, a thickness compensation effect of the thickness compensation portion 130 in the low thickness region 122b may be reduced. According to an embodiment, since the thickness compensation portion 130 is installed in the low thickness region 122b in which thickness compensation is required, not only an thickness compensation effect of the thickness compensation portion 130 be sufficiently achieved in the low thickness region 122b, but also a problem of space efficiency in the battery module being reduced due to installation of the thickness compensation portion 130 may be resolved.

The thickness compensation portion 130 may compensate for a reduced thickness of the electrode assembly 124 in the low thickness region 122b, as compared to a thickness T1 of the electrode assembly 124 in the uniform thickness region 122a. Since a thickness T2 of the low thickness region 122b has a smaller value than the thickness T1 of the uniform thickness region 122a, a difference in space in which the electrode assembly 124 may swell may occur between the uniform thickness region 122a and the low thickness region 122b, when swelling occurs in the battery cell 120. Therefore, surface pressure or pressing force applied to an electrode assembly in the low thickness region 122b by an adjacent battery cell 120 or the like may have a smaller value than surface pressure or pressing force applied to an electrode assembly in the uniform thickness region 122a. The thickness compensation portion 130 may compensate for the reduced thickness of the electrode assembly in the low thickness region 122b such that the surface pressure or the pressing force applied to the electrode assembly in the uniform thickness region 122a and the low thickness region 122b have similar or uniform values.

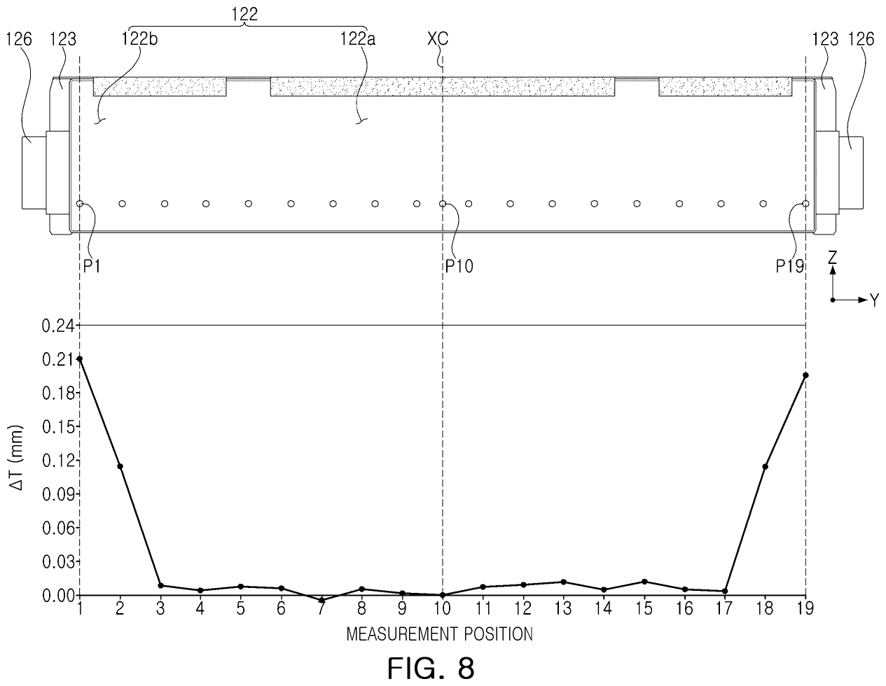

The thickness T of the thickness compensation portion 130 may have a value smaller than a difference between the thickness T1 of the electrode assembly 124 in the uniform thickness region 122a and the thickness T2 of the electrode assembly 124 in the low thickness region 122b. The thickness T1 of the electrode assembly 124 in the uniform thickness region 122a may be defined as an average thickness. As an example, if the difference between the average thickness T1 of the electrode assembly 124 in the uniform thickness region 122a and the thickness T2 of the electrode assembly 124 in the low thickness region 122b may be referred to as a thickness deviation (ΔT in FIG. 8), the thickness T of the thickness compensation portion 130 may have a value less than or equal to a maximum value of the thickness deviation ΔT.

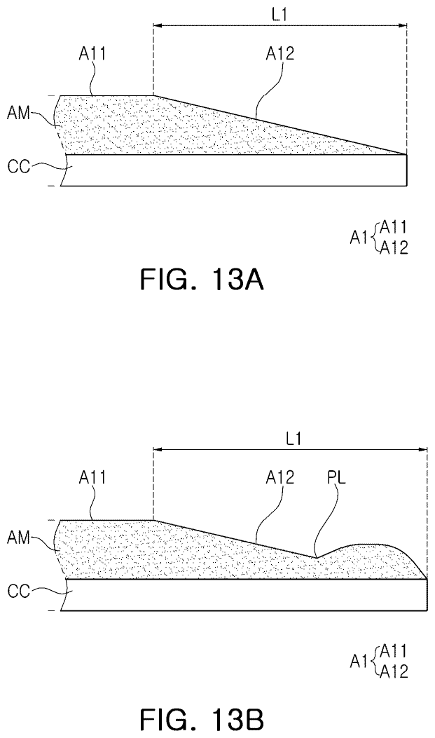

As an example, the thickness T2 of the electrode assembly 124 in the low thickness region 122b may have a minimum value in the end position P1 of the electrode plate. A point in which the thickness T2 of the electrode assembly 124 is minimum or a point in which the thickness deviation is maximum may be located in a point slightly away from the end position P1 of the electrode plate, depending on a process of applying a slurry (or active material) to the electrode plate (see FIG. 13B).

The thickness T of the thickness compensation portion 130 may be defined as a value measured in a state in which the thickness compensation portion 130 is not compressed when the thickness compensation portion 130: is an incompressible material, and may be defined as a value measured in a state in which the thickness compensation portion 130 is compressed by a preset value (e.g., 60%, 80%, etc.) when the thickness compensation portion 130 is a compressible material.

When the thickness compensation portion 130 is an incompressible material (e.g., rigid synthetic resin or the like), not compressed, the thickness compensation portion 130 may have the same or similar thickness in a pressurized state and an unpressurized state. When the thickness compensation portion 130 is a compressible material (e.g., polyurethane foam or the like), the thickness compensation portion 130 may have a thinner thickness in the pressurized state than in the unpressurized state. Even in the thickness compensation portion 130 of a compressible material, it may be difficult to compress easily, or an additional compression amount may be small when compressed by a preset value. Considering this, the thickness T of the thickness compensation portion 130 of the compressible material may be set to a value measured in the compressed state by a preset value (e.g., 60%, 80%, or the like).

In the first direction (Y) in which the electrode lead 126 extends from the electrode assembly 124, the width L of the thickness compensation portion 130 may have a value of 0.5 to 2.0 times a width of the low thickness region 122b. The width L of the thickness compensation portion 130 may have a value of 0.7 to 1.5 times, 0.8 to 1.2 times, or 0.8 to 1.0 times the width of the low thickness region 122b. For example, the thickness compensation portion 130 may cover more than half of the low thickness region 122b, to compensate for a thickness of the low thickness region 122b and increase a surface pressure. In addition, the thickness compensation portion 130 may cover most or all of the low thickness region 122b. When the width L of the thickness compensation portion 130 is too small (for example, smaller than 0.5 times the width of the low thickness region 122b), the thickness compensation portion 130 may not sufficiently cover the low thickness region 122b. Therefore, effects of thickness compensation and surface pressure increase of the low thickness region 122b may be reduced. When the width L of the thickness compensation portion 130 is too large (for example, more than 2.0 times the width of the low thickness region 122b), the thickness compensation portion 130 covers a large area of the uniform thickness region 122a. Therefore, effects of increasing a thickness of the battery cell 120 and thickness compensation of the low thickness region 122b may be reduced.

Since the thickness compensation portion 130 may be in contact with the body portion 122 of the battery cell 120, an electrically insulating material may be included therein to be insulated from the battery cell 120. When the insulation of the body portion 122 of the battery cell 120 is broken, current may flow through the thickness compensation portion 130 contacting the body portion 122. In this case, the thickness compensation portion 130 may act as an abnormal current path. Considering this, the thickness compensation portion 130 may have insulating properties. Insulating performance of the thickness compensation portion 130 may be set to be equal to or higher than insulating performance of a pouch 121 or insulating performance of a separator. For example, the insulating performance of the thickness compensation portion 130 may also be set to a value of 80 mega-ohm or higher. When another insulating material is disposed between the thickness compensation portion 130 and the body portion 122, electrical insulation of the thickness compensation portion 130 is not necessary or may have a lower level than those described above.

A material of the thickness compensation portion 130 may be polyurethane, silicone, or a rubber-based material, but various changes are possible.

The thickness compensation portion 130 may be attached to the low thickness region 122b of the body portion 122. For example, the thickness compensation portion 130 may be comprised of a solid such as a film, a tape, or the like, and may be attached to the low thickness region 122b. Alternatively, the thickness compensation portion 130 may be applied in a liquid form to the low thickness region 122b of the body portion 122, and may then be hardened. For example, the thickness compensation portion 130 may be comprised of a hardenable liquid material such as a hot melt adhesive, a thermal adhesive, or the like.

As illustrated in FIGS. 5A, 5B, and 6, the thickness compensation portion 130 may have a constant thickness in the first direction (Y) in which the electrode lead 126 extends from the electrode assembly 124.

The thickness T of the thickness compensation portion 130 may have a value less than or equal to the thickness deviation ΔT between the average thickness T1 of the electrode assembly 124 and the thickness 12 of the electrode assembly 124 in the low thickness region 122b, such that the low thickness region 122b may be pressed while the battery cells 120 may be stacked in a pressurized state.

FIG. 7 is a cross-sectional view illustrating a modified example having arrangement of the thickness compensation portion 130 illustrated in FIG. 5B. For convenience, FIG. 7 illustrates an exterior of a battery cell 120 and cross-sections of a thickness compensation portion 130 and a compression pad 128.

A cell assembly 110 illustrated in FIG. 7 may be different from the cell assembly 110 illustrated in FIG. 5B, in view that a compressible pad 128 is included and a thickness compensation portion 130′ is installed on the compressible pad 128.

A cell assembly 110 may include a compression pad 128 to absorb expansion due to swelling of a battery cell 120. The compression pad 128 may be installed between at least some battery cells 120 among battery cells 120, and may be compressed when the battery cell 120 expands, thereby absorbing expansion of the battery cell 120. The compression pad 128 may also be elastically deformed. The compression pad 128 may suppress expansion of an entire volume of the cell assembly 110 when swelling occurs. The compression pad 128 may be comprised of a polyurethane foam, but a material or a structure thereof is not limited thereto. The compression pad 128 may have a size corresponding to a body portion 122, but a size thereof may be changed in various manners.

When the compression pad 128 is disposed between adjacent battery cells 120, a thickness compensation portion 130′ may have a structure attached to the compression pad 128 or a low thickness region 122b of the body portion 122. For example, a thickness compensation portion 130′ may have a split structure attached to both sides of the compression pad 128. A thickness of the split thickness compensation portion 130′ may be half that of a thickness of a thickness compensation portion 130 located in a position in which the compression pad 128 is not attached. A method of combining the thickness compensation portion 130 and the compression pad 128 is not limited thereto, and the integral thickness compensation portion 130 may also be located in one side of the compression pad 128. The split thickness compensation portion 130′ may be comprised of a tape, a film, a hot melt adhesive, a thermal adhesive, or the like, and may be attached to the compression pad 128 or the body portion 122.

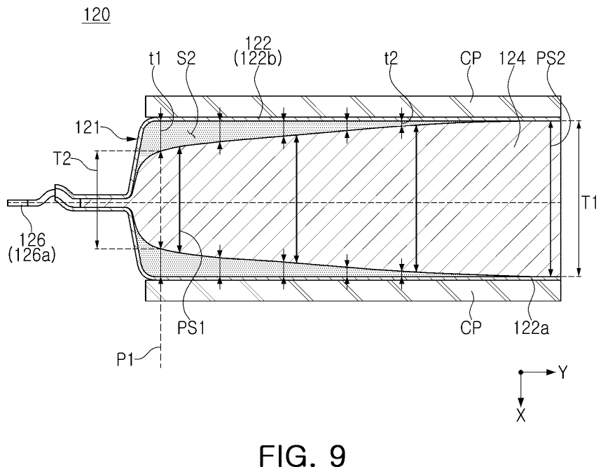

FIG. 8 is a graph illustrating a thickness deviation ΔT of an electrode assembly (124 of FIG. 4) in a battery cell 120 according to an embodiment, and FIG. 9 is a schematic view illustrating a change in thickness of an electrode assembly 124 in a portion adjacent to an electrode lead 126. FIG. 9 illustrates an internal state of a battery cell 120 when a battery cell 120 is pressed by a pressurizing pad CP. FIG. 10 illustrates electrode plates, in which portion (a) of FIG. 10 is a plan view of the electrode plate, and portion (b) of FIG. 10 is a cross-sectional view of the electrode plate.

Referring to FIG. 8 together with FIG. 4, an electrode assembly 124 of a battery cell 120 may be changed in thickness depending on a position. An upper drawing of FIG. 8 indicates 19 measurement positions P1 to P19 for measuring a thickness of the electrode assembly 124 in the first direction (Y) in which an electrode lead 126 extends, and a lower graph indicates a thickness deviation ΔT respectively measured in the measurement positions P1 to P19 in millimeters (mm). The measurement position P1 may be an end position of a first electrode plate (e.g., positive electrode plate), the measurement position P19 may be an end position of a second electrode plate (e.g., negative electrode plate), and the measurement position P10 may be an exact center (XC) of the electrode assembly 124. The graph of FIG. 8 illustrates the thickness deviation ΔT in each of the measurement positions, as compared to the thickness of the electrode assembly 124 in P10, which may be the exact center of the electrode assembly 124.

As illustrated in the graph of FIG. 8, the body portion 122 has a relatively uniform thickness in a uniform thickness region 122a, but it can be confirmed that a thickness of the electrode assembly 124 may be reduced in a low thickness region 122b adjacent to the electrode lead 126. Since the battery cell 120 illustrated in FIG. 8 has electrode leads 126 located in both sides of the body portion 122, the low thickness region 122b may be formed in both sides of the body portion 122.

As illustrated in FIG. 9, a thickness of an electrode assembly 124 may be reduced in a low thickness region 122b. For example, a thickness T2 of an electrode assembly 124 in a low thickness region 122b may have a smaller value than a thickness T1 of an electrode assembly 124 in a uniform thickness region 122a. As an example, the thickness T2 of the electrode assembly 124 in the low thickness region 122b may decrease toward a position adjacent to an electrode lead 126. The thickness T2 of the electrode assembly 124 in the low thickness region 122b may have a minimum value in an end position P1 of the electrode plate.

Referring to portions (a) and (b) in FIG. 10, a reason why a thickness of an electrode assembly 124 decreases in a portion adjacent to an electrode lead 126 will be described.

An electrode plate (positive and negative plates) constituting the electrode assembly may be coated with a slurry AM on a current collector CC formed of aluminum or copper. The slurry AM may include an active material, a conductive material, and a binder, and may be respectively coated on both surfaces of the current collector CC. The electrode plate may be divided into a coated area A1 on which the slurry AM containing an active material is applied, and a non-coated area A2 on which the slurry AM is not applied. The non-coated area A2 may have a constant second width L2, and may be cut into a constant shape to form an electrode tab 125. The coated area A1 may form a wide surface of the electrode plate. The coated area A1 and the non-coated area A2 may be cut, based on a cutting line CL, such that each thereof has a height corresponding to one electrode plate.

The non-coated area A2 may include a first non-coated area A21 disposed on one side of the electrode plate, and a second non-coated area A22 disposed on the other side of the electrode plate. The first non-coated area A21 may be provided as a positive electrode tab in a positive electrode plate, and the second non-coated area A22 may be provided as a negative electrode tab in a negative electrode plate.

The slurry AM may be in a fluid state, and may thus flow downwardly from edge areas A12 in both sides by self-load of the slurry AM. Therefore, thicknesses of the edge areas A12 in both sides may be respectively smaller than a thickness of a central portion A11. For example, the edge areas A12 in both sides may have an inclined shape. In this case, the edge areas A12 in both sides may have the smallest thickness at a boundary line BL with the non-coated portion A2. The edge areas A12 in both sides may be formed over a first width L1. When the electrode plates are stacked to form an electrode assembly, the edge areas A12 in both sides may form a low thickness region 122b, and the first width L1 may correspond to a width (L of FIG. 6) of the low thickness region 122b.

Referring again to FIG. 9, a gap t1 between an electrode assembly 124 and a body portion 122 in an end position P1 of the low thickness region 122b may be formed to be greater than a gap t2 between an electrode assembly 124 and a body portion 122, adjacent to the uniform thickness region 122a. Therefore, a space S2 in which the electrode assembly 124 is not located may be formed between the body portion 122 and the electrode assembly 124 in the low thickness region 122b. Due to this space S2, a surface pressure PS1 applied to the electrode assembly 124 in the low thickness region 122b may be smaller than a surface pressure PS2 applied to the electrode assembly 124 in the uniform thickness region 122a. Therefore, the battery cell 120 may have an uneven surface pressure in the low thickness region 122b, as compared to the uniform thickness region 122a. Since a distance between the electrode plates is longer in a portion in which surface pressure or pressing force is low, as compared to other positions, resistance between the electrode plates may increase as an electrolyte decreases. When resistance between the electrode plates increases, a lithium plating phenomenon rapidly reducing a lifespan of the battery cell 120 may occur.

An embodiment of the present disclosure may increase surface pressure or pressing force applied to the electrode assembly in the low thickness region 122b by disposing the thickness compensation portion (130 of FIG. 6) in the low thickness region 122b. In addition, the thickness compensation portion 130 may reduce a size of the space S2 occurring in the low thickness region 122b to reduce resistance between the electrode plates, and may alleviate or slow down a lithium plating phenomenon occurring in the electrode assembly (positive plate) in the low thickness region 122b. Therefore, according to an embodiment of the present disclosure, a problem of a lifespan of the battery cell 120 being rapidly reduced may be improved.

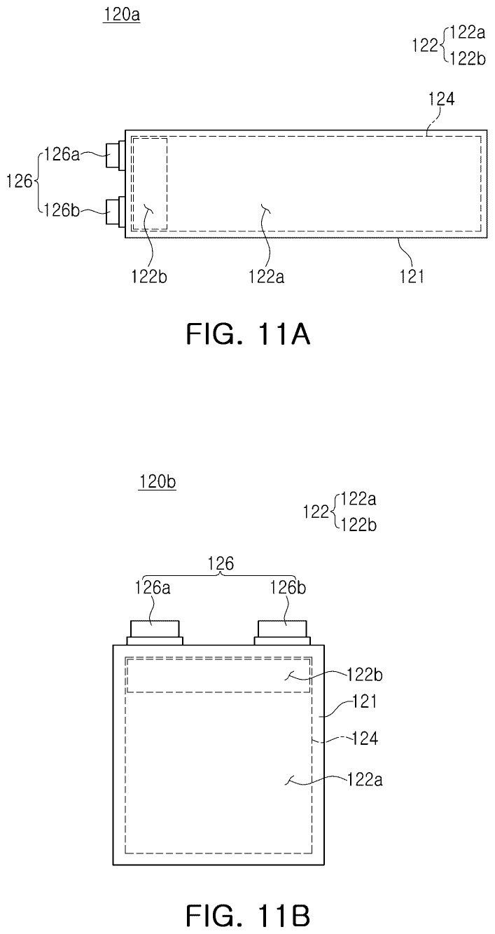

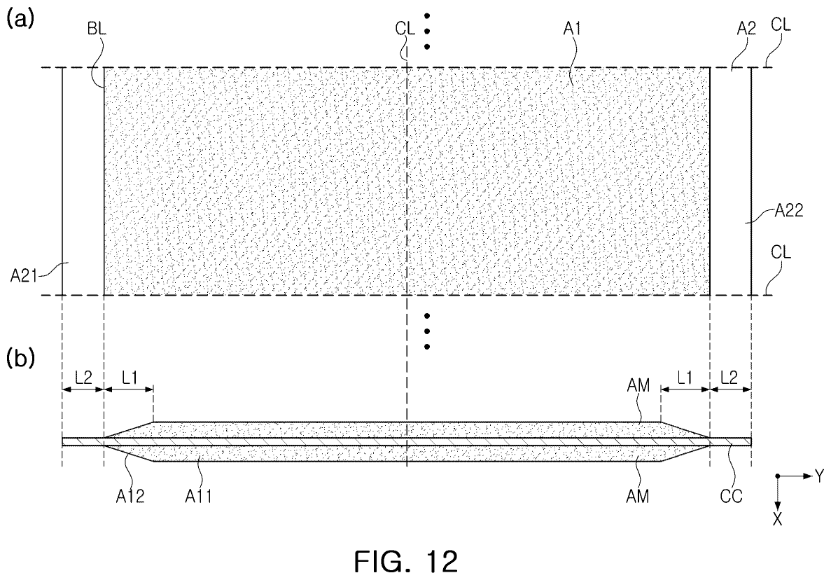

FIGS. 11A and 11B are schematic views illustrating a battery cell (120a, 120b) in which an electrode lead 126 is disposed in one side of a pouch 121, and FIG. 12 illustrates electrode plates, in which portion (a) of FIG. 12 is a plan view of the electrode plate, and portion (b) of FIG. 12 is a cross-sectional view of the electrode plate.

A battery cell 120a illustrated in FIG. 11A and a battery cell 120b illustrated in FIG. 11B may have a shape in which an electrode lead 126 may be disposed in one side of a pouch 121 or in one side of a body portion 122, respectively. For example, a positive electrode lead 126a and a negative electrode lead 126b may be disposed in one side of a pouch 121, respectively. In this case, a low thickness region 122b may be formed adjacent to a portion in which the electrode lead 126 is disposed, and a uniform thickness region 122a may be formed in a position spaced apart from the electrode lead 126, for example, in a position out of the low thickness region 122b.

In embodiments including the battery cell 120a illustrated in FIG. 11A and the battery cell 120b illustrated in FIG. 11B, the electrode lead 126 may have a shape extending from one side of an electrode assembly 124, the low thickness region 122b may be located in one side of the body portion 122, and a thickness compensation portion 130 may be disposed on the low thickness region 122b located in one side of the body portion 122.

Electrode plates of FIGS. 11A and 11B constituting the electrode assembly 124 may be formed by cutting along a cutting line CL illustrated in portions (a) and (b) of FIG. 12.

The cutting line CL may be formed across a central portion of a coated area A1, and accordingly, the electrode plate in one side may include a first non-coated area A21 and the coated area A1, and the electrode plate in the other side may include a second non-coated area A22 and the coated area A1. The first non-coated area A21 and the second non-coated area A22 may be cut into a certain shape to form a positive electrode tab or a negative electrode tab.

An edge area A12 adjacent to a boundary line BL between the coated area A1 and the non-coated area A2 forms a low thickness region 122b. In the battery cell illustrated in FIGS. 11A and 11B, a thickness compensation portion (130 of FIG. 2) may be disposed on the low thickness region 122b adjacent to the electrode lead 126, to increase surface pressure or pressing force applied to the electrode assembly 124 in the low thickness region 122b, and to alleviate or delay a lithium plating phenomenon occurring in the electrode assembly in the low thickness region 122b, thereby improving a problem of a rapid reduction in a lifespan of the battery cell.

FIGS. 13A and 13B are cross-sectional views illustrating a shape of an edge area.

FIG. 13A illustrates a shape of an edge area A12 having a constant slope toward an end portion, as illustrated in portion (b) of FIG. 10 and portion (b) of FIG. 12. The edge area A12 illustrated in FIG. 13A may have a shape in which a slurry AM flows in an outward direction by self-load of the slurry AM.

As illustrated in FIG. 13B, an edge area A12 may also have a shape having a point PL in which a thickness decreases and then increases. For example, a shape of an edge area A12 may be changed in various manners depending on a structure or a process of a slot coater applying a slurry AM to a current collector CC.

Since the edge area A12 is a portion in which the slurry AM has a smaller thickness than a central portion A11, a width L1 of the edge area may correspond to a value substantially equal to a width L of a low thickness region 122b. Considering that the edge area A12 is formed by flow of the slurry AM, the width L1 of the edge area or the width L of the low thickness region 122b may be set as a distance between an end portion of the electrode plate and a point further from the end portion of the electrode plate among a point 15% of a total length of the electrode plate away from the end portion of the electrode plate and a point 55 mm away from an end portion of an electrode plate.

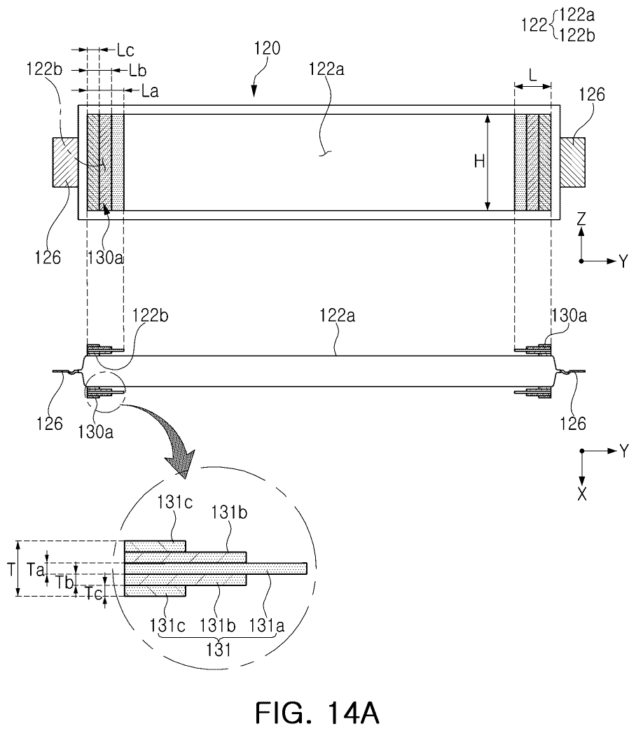

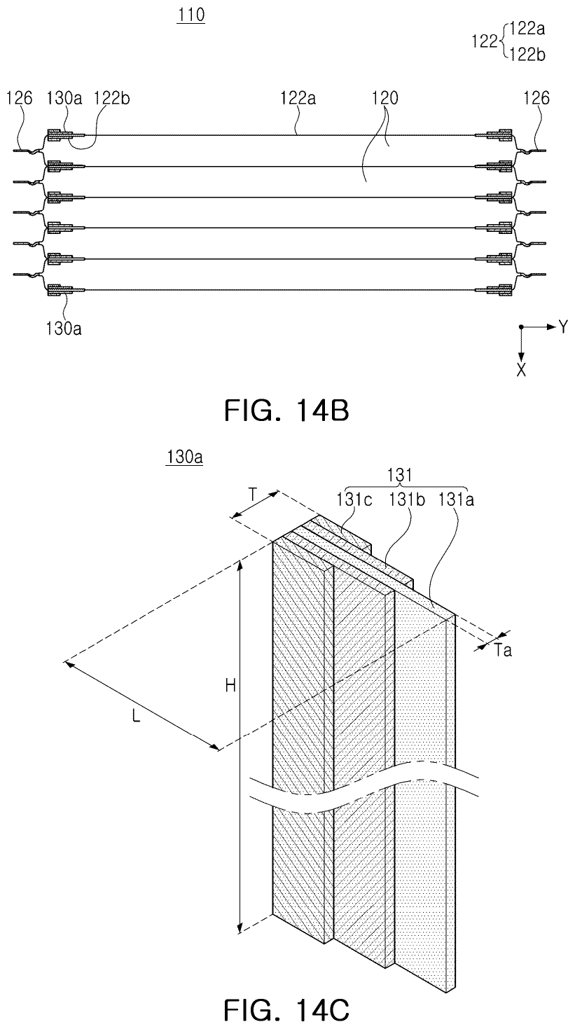

FIG. 14A is a schematic view illustrating a state in which a thickness compensation portion 130a according to a modified example is installed on both side surfaces of a battery cell 120, in which an upper portion in the drawing illustrates a side surface of the battery cell 120, and a lower portion in the drawing illustrates a plane of the battery cell 120. FIG. 14B is a cross-sectional view illustrating a state in which the thickness compensation portion 130a illustrated in FIG. 14A is disposed between battery cells 120, and FIG. 14C is a perspective view of the thickness compensation portion 130a illustrated in FIG. 14A.

A thickness compensation portion 130a illustrated in FIGS. 14A to 14C illustrates a modified example of the thickness compensation portion 130 illustrated in FIG. 5B, and there may be a difference in shape of a thickness compensation portion when compared to FIGS. 5A to 6. The descriptions of FIGS. 5A to 6 may also be applied to FIGS. 14A to 14C.

As illustrated in FIGS. 14A to 14C, in a thickness compensation portion 130a, a thickness of a portion close to an electrode lead 126 in the first direction (Y) in which the electrode lead 126 extends from an electrode assembly (124 of FIG. 4) may have a greater value than a thickness of a portion distant from the electrode lead 126.

For example, since a thickness of an electrode assembly in a low thickness region 122b may be thinner in a portion close to an electrode lead 126, a thickness of the thickness compensation portion 130a may have a greater value in a portion close to the electrode lead 126 than in a portion distant from the electrode lead 126.

In addition, the thickness compensation portion 130a may have a stepped cross-sectional shape. For example, the thickness compensation portion 130a may include a stepped portion 131 having a stepped difference. As an example, the stepped portion 131 may include a first portion 131a, a second portion 131b, and a third portion 131c. The number of stepped differences of the stepped portion 131 may be configured as two or four or more in consideration of a thickness change amount in the low thickness region 122b.

As illustrated in FIGS. 8 and 9 as examples, a thickness T2 of the electrode assembly 124 in the low thickness region 122b may decrease toward a position adjacent to the electrode lead 126. When the thickness compensation portion 130a has a stepped cross-sectional shape, a decrease in thickness T2 of the electrode assembly 124 in the low thickness region 122b may be compensated for, thereby uniformizing surface pressure applied to the electrode assembly 124 in the low thickness region 122b.

The first portion 131a may have a first thickness Ta and a first width La, the second portion 131b may be disposed on an outside of the first portion 131a and may have a second thickness Tb and a second width Lb, and the third portion 131c may be disposed on an outside of the second portion 131b, and may have a third thickness Tc and a third width Lc. In this case, the second width Lb may be greater than the third width Lc, and the first width La may be greater than the second width Lb. Values of the first thickness Ta, the second thickness Tb, and the third thickness Tc may also be set in consideration of a thickness change amount of the low thickness region 122b. As an example, the first width La may be 55 mm, the second width Lb may be 10 mm, the third width Lc may be 5 mm, and an overall width L of the thickness compensation portion 130a may be 55 mm. As an example, the first thickness Ta, the second thickness Tb, and the third thickness Tc of the thickness compensation portion 130a may be 0.05 mm, respectively, and an overall thickness T of the thickness compensation portion 130a may be 0.15 mm.

The first portion 131a, the second portion 131b, and the third portion 131c may have a shape in which a tape, a film, or the like are stacked, but may also be configured as an integral body.

The width L of the thickness compensation portion 130a may correspond to the first width La of the first portion 131a, and may have a value corresponding to a length of the low thickness region 122b. A height H of the thickness compensation portion 130a may have a value corresponding to a height of the low thickness region 122b or a height of the body portion 122. The thickness T of the thickness compensation portion 130a may have a value less than or equal to a maximum value of a thickness deviation (ΔT in FIG. 8), which may be a difference between thicknesses T2 of the electrode assembly 124 in the uniform thickness region 122a and the low thickness region 122b.

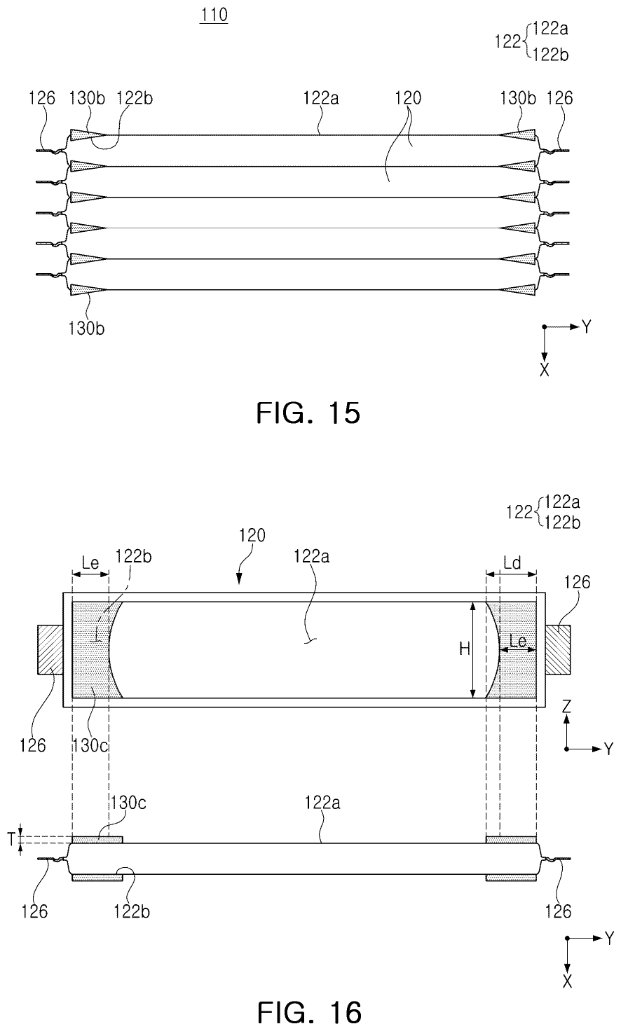

FIG. 15 is a cross-sectional view illustrating a state in which a thickness compensation portion 130b according to another modified example is disposed between battery cells 120.

A thickness compensation portion 130b illustrated in FIG. 15 illustrates a modified example of the thickness compensation portion 130 illustrated in FIG. 5B, and there may be a difference in shape of a thickness compensation portion when compared to FIGS. 5A to 6. The descriptions of FIGS. 5A to 6 may also be applied to FIG. 15.

As illustrated in FIG. 15, in a thickness compensation portion 130b, a thickness of a portion close to an electrode lead 126 in the first direction (Y) in which the electrode lead 126 extends from an electrode assembly may have a greater value than a thickness of a portion distant from the electrode lead 126.

The thickness compensation portion 130b may have a shape in which a thickness decreases from a portion close to the electrode lead 126 to a portion distant from the electrode lead 126.

For example, in a low thickness region 122b, when a thickness of an electrode assembly 124 decreases from a portion distant from the electrode lead 126 to a portion close to the electrode lead 126, the thickness compensation portion 130b may have a sloped cross-sectionals shape such that a thickness of the portion close to the electrode lead 126 is greater. In this case, the thickness compensation portion 130b may compensate for thickness reduction of the electrode assembly 124 in the low thickness region 122b, and thus may uniformize surface pressure applied to the electrode assembly 124 in the low thickness region 122b.

FIG. 16 is a schematic view illustrating a state in which a thickness compensation portion 130c according to another modified example is installed on both side surfaces of a battery cell 120, in which an upper portion in the drawing illustrates a side surface of the battery cell 120, and a lower portion in the drawing illustrates a plane of the battery cell 120.

When swelling occurs in a battery cell 120, pressure and an amount of expansion applied to a central portion of a body portion 122 may be the largest, and an edge portion may have relatively small values therefor. For example, pressure applied due to swelling may have a large value at the central portion and a small value in an outer side portion, based on the first direction (Y) and the third direction (Z), respectively. Therefore, isobars of the pressure applied due to swelling may have a convex arc shape from the central portion in an outward direction.

When swelling occurs in the battery cell 120, a shape of a thickness compensation portion 130c may be set to correspond to shapes of the isobars acting due to swelling such that a uniform surface pressure is provided to a low thickness region 122b.

In this case, an inner side portion of the thickness compensation portion 130c may have a shape in which an outer side portion of the thickness compensation portion 130c in the height direction extends further toward a uniform thickness region 122a than a central portion of the thickness compensation portion 130c in the height direction. For example, a width Ld of the outer side portion of the thickness compensation portion 130c in the height direction may have a value greater than a width Le of the central portion of the thickness compensation portion 130c in the height direction. The inner side surface of the thickness compensation portion 130c may have an arc shape.

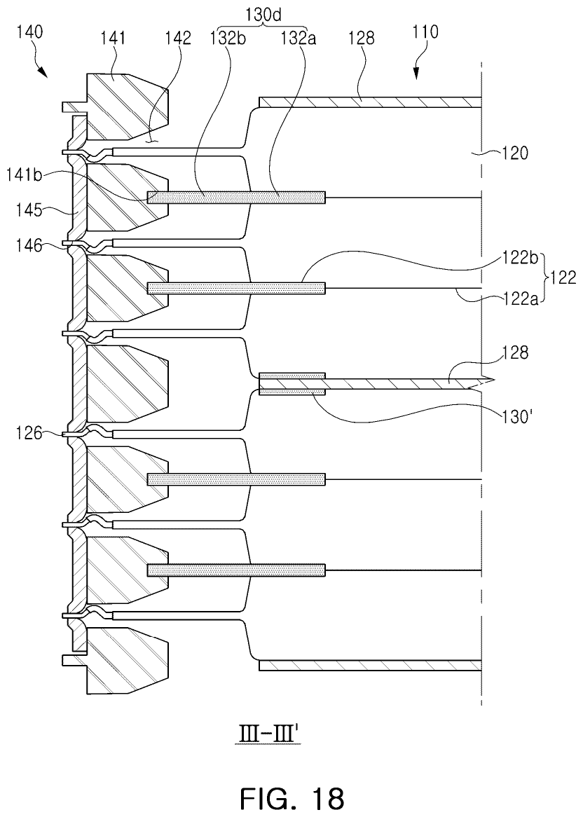

FIG. 17 is a cross-sectional view of FIG. 2, taken along line III-III′, and FIG. 18 is a cross-sectional view illustrating a modified example of FIG. 17. For convenience and clarity, FIGS. 17 and 18 illustrate an exterior of a battery cell 120.

As illustrated in FIGS. 17 and 18, an embodiment of the present disclosure may include a cell assembly 110 including a plurality of battery cells 120, a busbar assembly 140 including a busbar 145 connected to electrode leads 126 of the battery cells 120, and a support plate 141 supporting the busbar 145.

As illustrated in FIGS. 17 and 18, a thickness compensation portion 130d may be connected to the support plate 141. As an example, the thickness compensation portion 130d may be formed integrally with the support plate 141 or may be attached to the support plate 141.

As an example, the thickness compensation portion 130d may include an insertion portion 132a installed between the battery cells 120 to face a low thickness region 122b of the battery cell 120, and a coupling portion 132b extended from the insertion portion 132a and connected to the support plate 141. The thickness compensation portion 130d may be manufactured separately from the support plate 141, and may be attached to the support plate 141, but may also be formed integrally with the support plate 141.

A compression pad 128 may be disposed between at least some battery cells 120. When the compression pad 128 is disposed between adjacent battery cells 120, a thickness compensation portion 130′ may have a structure attached to the compression pad 128 or the low thickness region 122b of a body portion 122. A thickness of the thickness compensation portion 130′ may have a value half of a thickness of the thickness compensation portion 130d disposed in a position in which the compression pad 128 is not attached.

As compared to the thickness compensation portion 130d of FIG. 17, the thickness compensation portion 130d of FIG. 18 may be different in that the coupling portion 132b is connected to a fitting groove 141b of the support plate 141. The coupling portion 132b may be attached to the support plate 141 while being inserted into the fitting groove 141b of the support plate 141. In this case, the thickness compensation portion 130d may be manufactured separately from the support plate 141, and may be attached to the support plate 141.

In embodiments illustrated in FIGS. 17 and 18, the thickness compensation portion 130d may be connected to the support plate 141 of the busbar assembly 140, and may thus have a state of connection to the support plate 141. Therefore, since the thickness compensation portion 130d may be disposed between at least some battery cells 120 in a process of connecting the electrode lead 126 of the cell assembly 110 to the busbar 145, an installation operation of the thickness compensation portion 130d may be easily performed.

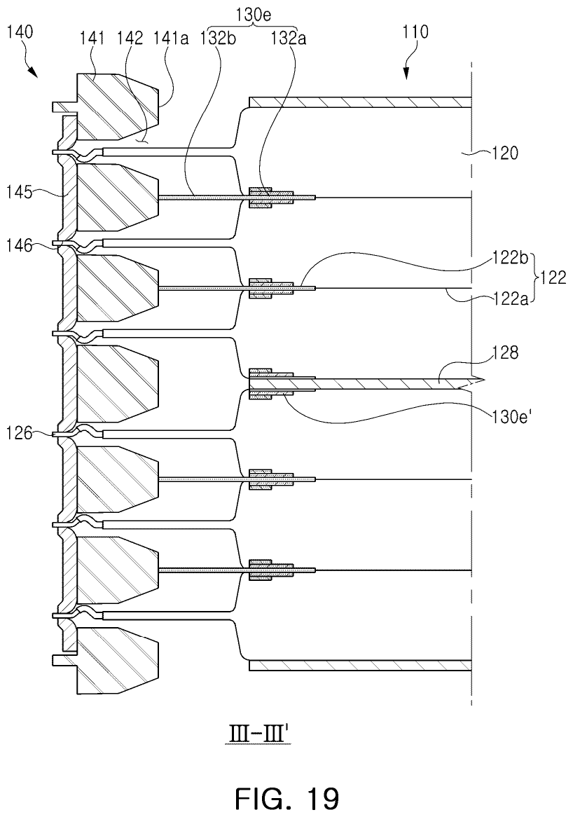

FIG. 19 is a cross-sectional view illustrating a state in which a modified example of the thickness compensation portion 130d illustrated in FIG. 17 is applied.

As compared to the thickness compensation portion 130d of FIG. 17, a thickness compensation portion 130e of FIG. 19 may include a stepped cross-sectional shape. The thickness compensation portion 130e may include a pressing portion 132a installed between battery cells 120 to face a low thickness region 122b of a battery cell 120, and a coupling portion 132b extended from the pressing portion 132a and connected to a support plate 141. The pressing portion 132a may have a shape similar to the thickness compensation portion 130a illustrated in FIGS. 14A to 14C.

In the embodiment illustrated in FIG. 19, since the thickness compensation portion 130e may be disposed between at least some battery cells 120 in a process of connecting an electrode lead 126 of a cell assembly 110 to a busbar 145, an installation operation of the thickness compensation portion 130e may be easily performed.

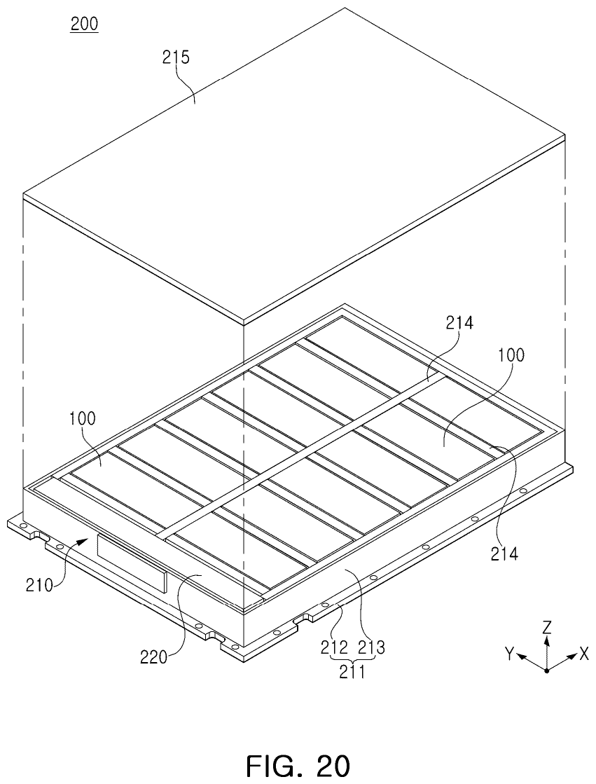

FIG. 20 is an exploded perspective view illustrating a battery pack according to an embodiment of the present disclosure.

Referring to FIG. 20, a battery pack 200 may include a plurality of battery modules 100 and a pack housing 210 accommodating the plurality of battery modules 100. The descriptions of the battery module 100 described in FIGS. 1 to 19 may be applied to a battery module 100 of FIG. 20.

The pack housing 210 may accommodate components installed in the battery pack 200, such as the battery module 100 and the like. The pack housing 210 may include a housing body 211 supporting the battery module 100, and a pack cover 215 covering the housing body 211. The housing body 211 may include a bottom member 212 and a side wall 213. The pack housing 210 may include a partition 214 crossing a space in which the battery module 100 is installed. For example, an accommodation space of the pack housing 210 may be divided into a plurality of spaces by the partition 214. The partition 214 may be installed across the accommodation space to reinforce rigidity of the pack housing 210.

The battery pack 200 may include a battery controller 220 controlling the battery module 100. The battery controller 220 may be disposed in the pack housing 210. The battery controller 220 may include a battery management system (BMS). A configuration of the battery controller 220 may be known in various forms, and a detailed description thereof will be thus omitted. In an embodiment, the battery controller 220 may be referred to as a processor.

According to an embodiment of the present disclosure, a lifespan of a battery module and/or a lifespan of a battery pack may be increased.

According to an embodiment of the present disclosure, a problem of rapidly decreasing in capacity or rapidly increasing in resistance in a battery cell provided to a battery module may be improved.

According to an embodiment of the present disclosure, although a thickness compensation portion is disposed between at least some battery cells, energy density of a battery module may be limited from being reduced due to the placement of the thickness compensation portion.

Only specific examples of implementations of certain embodiments may be described. Variations, improvements and enhancements of the disclosed embodiments and other embodiments may be made based on the disclosure of this patent document.

What is claimed is:

1. A battery module comprising:
a cell assembly including a plurality of battery cells, each of the plurality of battery cells including a body portion accommodating an electrode assembly, a sealing portion sealing at least a portion of a periphery of the body portion, and an electrode lead electrically connected to the electrode assembly; and
a thickness compensation portion disposed between at least some battery cells among the plurality of battery cells,
wherein the body portion includes a uniform thickness region including a central portion of the body portion, and a low thickness region disposed adjacent to the electrode lead than the uniform thickness region, and
the thickness compensation portion has a shape covering at least a portion of the low thickness region and not covering at least a portion of the uniform thickness region.

2. The battery module of claim 1, wherein, if a difference between an average thickness of the electrode assembly in the uniform thickness region and a thickness of the electrode assembly in the low thickness region is referred to as a thickness deviation,
a thickness of the thickness compensation portion has a value less than or equal to a maximum value of the thickness deviation.

3. The battery module of claim 2, wherein the thickness of the thickness compensation portion is:
a value measured in a state in which the thickness compensation portion is not compressed, when the thickness compensation portion is an incompressible material, and
a value measured in a state in which the thickness compensation portion is compressed by a preset value, when the thickness compensation portion is a compressible material.

4. The battery module of claim 1, wherein the thickness compensation portion includes an electrically insulating material.

5. The battery module of claim 1, wherein the thickness compensation portion has a constant thickness in a first direction in which the electrode lead extends from the electrode assembly.

6. The battery module of claim 1, wherein, in a first direction in which the electrode lead extends from the electrode assembly, a thickness of a portion of the thickness compensation portion adjacent to the electrode lead is greater than a thickness of a portion of the thickness compensation portion distant from the electrode lead.

7. The battery module of claim 6, wherein the thickness compensation portion has a stepped cross-sectional shape.

8. The battery module of claim 6, wherein the thickness compensation portion has a shape of which a thickness decreases from a portion adjacent to the electrode lead to a portion distant from the electrode lead.

9. The battery module of claim 1, wherein the thickness compensation portion has a height, equal to or greater than a height of an electrode plate provided in the electrode assembly.

10. The battery module of claim 9, wherein an inner side portion of the thickness compensation portion has a shape in which an outer side portion of the thickness compensation portion in a height direction extends further toward the uniform thickness region than a central portion in the height direction.

11. The battery module of claim 1, wherein a width of the thickness compensation portion in a first direction in which the electrode lead extends from the electrode assembly has a value of 0.5 to 2.0 times a width of the low thickness region.

12. The battery module of claim 1, wherein the electrode lead has a shape extending from both sides of the electrode assembly,
the low thickness region is located on both sides of the body portion, and
the thickness compensation portion is disposed on the low thickness region, respectively.

13. The battery module of claim 1, wherein the electrode lead has a shape extending from one side of the electrode assembly,
the low thickness region is located in one side of the body portion, and
the thickness compensation portion is disposed on the low thickness region located in the one side of the body portion.

14. The battery module of claim 1, further comprising a busbar assembly including a busbar connected to an electrode lead of a battery cell, and a support plate supporting the busbar,
wherein the thickness compensation portion is connected to the support plate.

15. The battery module of claim 14, wherein the thickness compensation portion is formed integrally with the support plate or attached to the support plate.

16. A battery pack comprising:
a plurality of battery modules; and
a pack housing accommodating the plurality of battery modules,
wherein at least one battery module, among the plurality of battery modules, includes:
a cell assembly including a plurality of battery cells, each of the plurality of battery cells including a body portion accommodating an electrode assembly, a sealing portion sealing at least a portion of a periphery of the body portion, and an electrode lead electrically connected to the electrode assembly; and
a thickness compensation portion disposed between at least some battery cells among the plurality of battery cells,
wherein the body portion includes a uniform thickness region including a central portion of the body portion, and a low thickness region disposed adjacent to the electrode lead than the uniform thickness region, and
the thickness compensation portion has a shape covering at least a portion of the low thickness region and not covering at least a portion of the uniform thickness region.
